(19) United States
(12) Patent Application Publication
(10) Pub. No.: US 2014/0305039 A1
(43) Pub. Date: Oct. 16, 2014

(54) Vertically Adjustable Organism Housing Assembly

(71) Applicant: Kip Andersen, San Francisco, CA (US)

(72) Inventor: Kip Andersen, San Francisco, CA (US)

(21) Appl. No.: 13/860,503

(22) Filed: Apr. 10, 2013

(51) Int. Cl. A01G 9/02

(52) U.S. Cl. CPC A01G 9/02
USPC 47/65.5

(57) ABSTRACT

An organism housing assembly that vertically reconfigures to provide variable sizes and dimensions that increase and decrease according to the spatial requirements of an organism, such as a plant. A housing covers the plant through various stages of the plant's life. The housing initially encloses an early organism. Subsequently, the housing vertically adjusts to a larger size and dimension to cover a mature organism. A fabric sleeve portion protects the plant. The sleeve portion may have a reflective inner surface and an outer surface fabricated to block infra-red radiation. At least one support portion, such as poles support the fabric sleeve. Each pole extends from a ground surface to provide a framework for supporting the housing. Additional poles can join the initial poles to expand the size of the housing. A fastener on the sleeve portion allows access to the poles and the housing.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to organism housing assemblies. More particularly, one or more embodiments of the invention relate to adjustable housing for growing a plant.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that plants are living organisms of the kingdom Plantae including such multicellular groups as flowering plants, conifers, ferns, and mosses.

Typically, most of the solid material in a plant is taken from the atmosphere through a process known as photosynthesis. Most plants use the energy in sunlight to convert carbon dioxide from the atmosphere, plus water, into simple sugars.

Typically, a grow light is an artificial light source, generally an electric light, designed to stimulate plant growth by emitting an electromagnetic spectrum appropriate for photosynthesis. Grow lights may be used in applications where there is either no naturally occurring light, or where supplemental light is required.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate a detailed perspective view of an exemplary adjustable organism housing, where FIG. 1A illustrates an exemplary adjustable organism housing in an initial configuration, and FIG. 1B illustrates an adjustable organism housing in an expanded configuration in accordance with an embodiment of the present invention; and

FIGS. 2A and 2B illustrate a sectioned view of an exemplary adjustable organism housing, where FIG. 2A illustrates an exemplary adjustable organism housing in an initial configuration supported by at least one support portion, and FIG. 2B illustrates an adjustable organism housing in an expanded configuration supported by at least one support portion, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of adjustable organism housings that may be provided by preferred embodiments of the present invention. In one embodiment of the present invention, the adjustable organism housing may adjustably reconfigure to provide variable sizes and dimensions that increase and decrease according to the spatial requirements of a organisms. The organisms may include, without limitation, plants, fruits, vegetables, flowers, blooms, herbs, and spices, animals, fungi, and micro-organisms. In one embodiment, the housing may contain an organism, such as a plant, in various stages of life. The organism may range from the early stages of growth to the mature stages of growth. The housing may initially, at least partially enclose an early organism from an initial configuration. After a period of time, the housing may adjust to a larger size and dimension to at least partially cover a mature organism from an expanded configuration. Those skilled in the art, in light of the present teachings, will recognize that the early organism may include a plant between a vegetative stage to a reproductive stage. A mature organism may include the plant from a senescence stage to a dormancy stage. However, a user may adjustably size the housing for other factors, including, without limitation, height, width, odor, growth potential, and harvesting. The housing may increase in size and dimension to correlate with an increasing organism size. In some embodiments, the housing may increase in height to an extended configuration for accommodating the natural growth of organisms. The housing may then be adjusted to the initial configuration when newer, younger organisms replace the older organisms. Those skilled in the art, in light of the present teachings, will recognize that the increased height of the housing may provide a more organism-friendly environment. Factors that may enhance the growing environment in a larger housing, may include, without limitation, increased air flow, additional light, additional space for storing fertilizers, and additional space for organism enhancing equipment. The additional height of the housing may further provide extra space for a user to walk within the housing. In some embodiments, the housing may include organism enhancing equipment for enhancing the organism's growth. The organism enhancing equipment may include, without limitation, lamps, reflector hoods, and hydroponic systems located inside the housing.

In one embodiment of the present invention, the housing may include a fabric sleeve portion that at least partially encloses the organism inside the housing. The fabric sleeve portion may be operable to stretch or be transparent for further enhancing the environment of the organism. The fabric sleeve portion may include a conductive inner surface configured to increase light intensity within the housing. The housing may further include an outer surface. In some embodiments, at least one support portion may support the fabric sleeve. The at least one support portion may include at least one pole. Each pole may extend from a ground surface and provide a framework to support the housing. Additional support portion may be added to the initial support portions to increase the size and dimensions of the housing. In this manner, the height of the housing may be increased. In some embodiments, the fabric sleeve portion may include a fastener for providing access to the at least one support portion. The fastener may include, without limitation, a zipper, a button, a magnet, and a hook and loop strap.

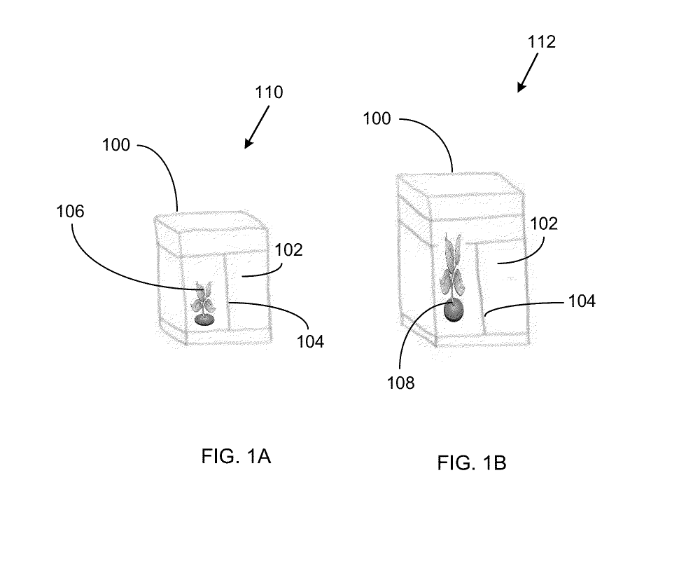

FIGS. 1A and 1B illustrate a detailed perspective view of an exemplary adjustable organism housing, where FIG. 1A illustrates an exemplary adjustable organism housing in an initial configuration, and FIG. 1B illustrates an adjustable organism housing in an expanded configuration in accordance with an embodiment of the present invention. In the present invention, an adjustable organism housing 100 may adjustably reconfigure to provide variable sizes and dimensions that increase and decrease according to the spatial requirements of a organisms. The organisms may include, without limitation, plants, fruits, vegetables, flowers, blooms, herbs, and spices, animals, fungi, and micro-organisms. In one embodiment, the housing may contain an organism, such as a plant, in various stages of life. The organism may range from the early stages of growth to the mature stages of growth. The housing may initially, at least partially, enclose an early organism 106 from an initial configuration 110. After a period of time, the housing may adjust to a larger size and dimension to at least partially cover a mature organism 108 from an expanded configuration 112. Those skilled in the art, in light of the present teachings, will recognize that the early organism may include a plant between a vegetative stage to a reproductive stage. A mature organism may include the plant from a senescence stage to a dormancy stage. However, a user may adjustably size the housing for other factors, including, without limitation, height, width, odor, growth potential, and harvesting. In some embodiments, the size adjustments may require manual positioning of various components. However, in other embodiments, the resizing may be operable by other means, including, without limitation, electrical, remote control, and trigger release spring mechanisms. The housing may increase in size and dimension to correlate with an increasing organism size. In some embodiments, the housing may increase in height to an extended configuration for accommodating the natural growth of organisms. The housing may then be adjusted to the initial configuration when newer, younger organisms replace the older organisms. However, in other embodiments, the width may also be increased and decreased as required to accommodate organism growth.

Those skilled in the art, in light of the present teachings, will recognize that the increased height of the housing may provide a more organism-friendly environment. Factors that may enhance the growing environment in a larger housing, may include, without limitation, increased air flow, additional light, additional space for storing fertilizers, and additional space for organism enhancing equipment. The additional height of the housing may further provide extra space for a user to walk within the housing, or organism enhancing equipment to position inside. The organism enhancing equipment may include, without limitation, lamps, reflector hoods, and hydroponic systems. In some embodiments, the housing may include an initial dimension of 150 cm×150 cm×200 cm. However, the housing may increase or decrease in size with adjusting. The housing may be configured into various shapes, including, without limitation, a rectangle, a square, a sphere, and a pyramid. In some embodiments, a fabric sleeve portion 102 supported by poles may provide the framework for the adjustable organism housing. A fastener 104 may provide access to the inside of the housing and the poles.

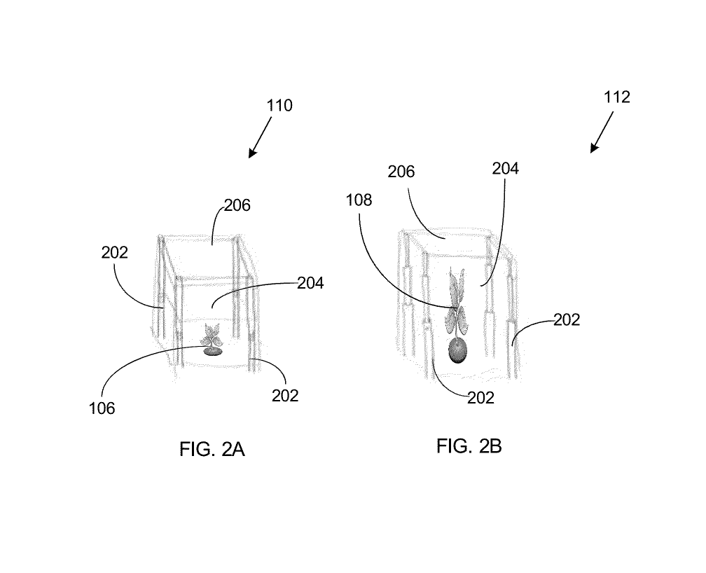

FIGS. 2A and 2B illustrate a sectioned view of an exemplary adjustable organism housing, where FIG. 2A illustrates an exemplary adjustable organism housing in an initial configuration supported by at least one support portion, and FIG. 2B illustrates an adjustable organism housing in an expanded configuration supported by at least one support portion, in accordance with an embodiment of the present invention. In the present invention the housing may include a fabric sleeve portion that encloses organisms inside the housing. The fabric sleeve portion may include a conductive inner surface 204 configured to increase light intensity within the housing. In one embodiment, the inner surface may be lined with 95% reflective hammered effect Mylar™ fabric with a thickness of 210D. The housing may further include an outer surface 206 for shielding the organisms from the environment, including, without limitation, adverse weather, sunlight, excessive winds, and pollutants. In yet another embodiment, the outer surface may inhibit penetration from infrared radiation. In some embodiments, the fabric sleeve portion may inhibit penetration of odors from within the housing. Suitable materials for the fabric sleeve may include, without limitation, 1680D threaded, reflective fabric, polyester, plastic, fiberglass, synthetics, cotton, and metal. In some embodiments, the fabric sleeve portion may include perforations for enhancing air circulation inside the housing.

In some embodiments, at least one support portion 202 may support the fabric sleeve. The at least one support portion may include at least one pole. Each pole may extend from a ground surface and provide a framework for the housing. Additional support portion may be added or removed to the initial support portions to adjustable increase or decrease the size and dimensions of the housing, including, without limitation, wires from a ceiling, poles that extend from a proximal barrier, and exhaust fans that blow air against the inner surface to form a desired shape for the housing. In this manner, the height of the housing may be adjustable to increase or decrease as desired. In some embodiments, the at least one support portion may include telescoping poles that extend and retract as required. A stretchable fabric sleeve portion may conform to the extensions and retractions of the telescoping poles. In this manner, additional poles may not be necessary to attach to the initial poles. In some embodiments, the fabric sleeve portion may include a fastener for providing access to the interior of the housing, and the at least one support portion. The fastener may include, without limitation, a zipper, a button, a magnet, and a hook and loop strap. In some embodiments, the fastener may allow partial opening of the housing to allow air to circulate.

In one alternative embodiment, the housing may automatically increase or decrease in size and dimension in direct correlation with the organism. For example, without limitation, the housing may increase in height upon contacting or sensing a close proximity with the organisms. Upon sensing smaller organisms that do not require large spaces, the housing may then decrease in size and dimensions to correlate with the size of the organism. In this manner, a user does not have to manually resize the housing, or approximate the expected organism growth. In yet another embodiment, the housing may include various sizes and dimensions to accommodate different types of organisms and organism growth rates.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing adjustable organism growth housing according to the present invention will be apparent to those skilled in the art. Various aspects of the invention have been described above by way of illustration, and the specific embodiments disclosed are not intended to limit the invention to the particular forms disclosed. The particular implementation of the adjustable organism growth housing may vary depending upon the particular context or application. By way of example, and not limitation, the adjustable organism growth housing described in the foregoing were principally directed to support structures that can be added to a organism growth housing to increase size and dimension implementations; however, similar techniques may instead be applied to photo studios, video studios, and dark houses for developing film which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An assembly comprising:
a housing, said housing being configured to at least partially enclose an early organism and a mature organism, said housing being operable to extend along a vertical dimension, said housing comprising a sleeve portion, said sleeve portion being configured to at least partially enhance said early organism and said mature organism, said sleeve portion comprising an inner surface, said housing further comprising an outer surface; and
at least one support portion, said at least one support portion being configured to support said housing, said at least one support portion being operable to adjustably configure said housing along said vertical dimension.

2. The assembly of claim 1, in which said assembly comprises a vertically adjustable organism housing assembly.

3. The assembly of claim 1, in which said organism comprises a plant.

4. The assembly of claim 1, in which said early organism comprises said plant between a vegetative stage and a reproductive stage.

5. The assembly of claim 1, wherein said housing is configured in an initial configuration operable to at least partially enclose said early organism.

6. The assembly of claim 1, in which said mature organism comprises said plant between a senescence stage and a dormancy stage.

7. The assembly of claim 1, in which said housing is configured in an expanded configuration operable to at least partially enclose said mature organism.

8. The assembly of claim 1, in which said sleeve portion comprises a fastener.

9. The assembly of claim 1, wherein said fastener is configured to allow access to said housing and said at least one support portion.

10. The assembly of claim 9, in which said fastener comprises a zipper.

11. The assembly of claim 1, wherein said sleeve portion is operable to stretch.

12. The assembly of claim 1, in which said sleeve portion comprises a 1680D threaded, reflective fabric.

13. The assembly of claim 1, in which said inner surface comprises a reflective surface.

14. The assembly of claim 1, wherein said outer surface is operable to at least partially block infra-red.

15. The assembly of claim 1, in which said at least one support portion comprises at least one pole.

16. The assembly of claim 1, in which said at least one support portion is operable to combine for increasing said vertical dimension.

17. The assembly of claim 1, in which said at least one support portion is operable to detach for decreasing said vertical dimension.

18. The assembly of claim 1, in which said assembly comprises a plant enhancing equipment.

19. An assembly comprising:
means for positioning an organism inside a housing;
means for configuring said housing to an initial configuration;
means for growing said organism;
means for extending at least one support portion; and
means for configuring said housing to a vertically expanded configuration.

20. An assembly consisting of:
a housing, said housing being configured to at least partially enclose an organism, said organism comprising a plant, said organism comprising an early organism, said organism further comprising a mature organism, said housing being operable to extend along a vertical dimension, said housing comprising a sleeve portion, said sleeve portion being configured to at least partially enhance said early organism and said mature organism, said sleeve portion comprising a 1680D threaded, reflective fabric. said sleeve portion comprising an inner surface, said inner surface comprising a reflective surface, said housing further comprising an outer surface, said outer surface being operable to at least partially block infra-red, said sleeve portion further comprising a fastener, said fastener being operable to provide access to said at least one support portion, said fastener comprising a zipper; and
at least one support portion, said at least one support portion comprising at least one pole, said at least one support portion being configured to support said housing, said at least one support portion being operable to adjustably configure said housing into said vertical dimension.
